(19) United States
(12) Patent Application Publication
(10) Pub. No.: US 2011/0236169 A1
(43) Pub. Date: Sep. 29, 2011

(54) TEMPERATURE AND HUMIDITY CONTROL CHAMBER

(75) Inventors: HUNG-CHOU CHAN, Tu-Cheng (TW); ZHEN-XING YE, Shenzhen (CN); XIAO-FENG MA, Shenzhen (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/869,932

(22) Filed: Aug. 27, 2010

(30) Foreign Application Priority Data
Mar. 23, 2010 (CN) 201010130684.9

(51) Int. Cl. B66F 1/00

(52) U.S. Cl. 414/586

(57) ABSTRACT

A temperature and humidity control chamber includes a housing defining a receiving chamber, a support frame received in the receiving chamber, four elevating members supporting the support frame, four driving assemblies mounted on the housing, and a controller operable to control the driving assemblies. The four elevating members are capable of moving the support frame from a first vertical position to a second vertical position.

### BACKGROUND

1. Technical Field

The present disclosure relates to a temperature and humidity control chamber.

2. Description of Related Art

A temperature and humidity control chamber provides an environment in which temperature and humidity can be precisely controlled, to determine the effect of such environment variations on test subjects, such as test subjects and systems. A commonly used temperature and humidity control chamber includes a housing defining a receiving chamber, and a support frame received in the chamber providing vertical support for the test subject. Opposite side surfaces of the receiving chamber form a plurality of protrusions arranged in various vertical positions for retaining the support frame at a variety of heights. During testing, a test subject is placed on the support frame. However, when the vertical position of the test subject is to be adjusted, the test subject must be removed from the receiving chamber, and be replaced on the protrusions in the new position, which is an inconvenient and time-wasting requirement.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric, assembled view of one embodiment of a temperature and humidity control chamber.

FIG. 2 is a cross section of the temperature and humidity control chamber of FIG. 1 omitting a support frame and a controller.

### DETAILED DESCRIPTION

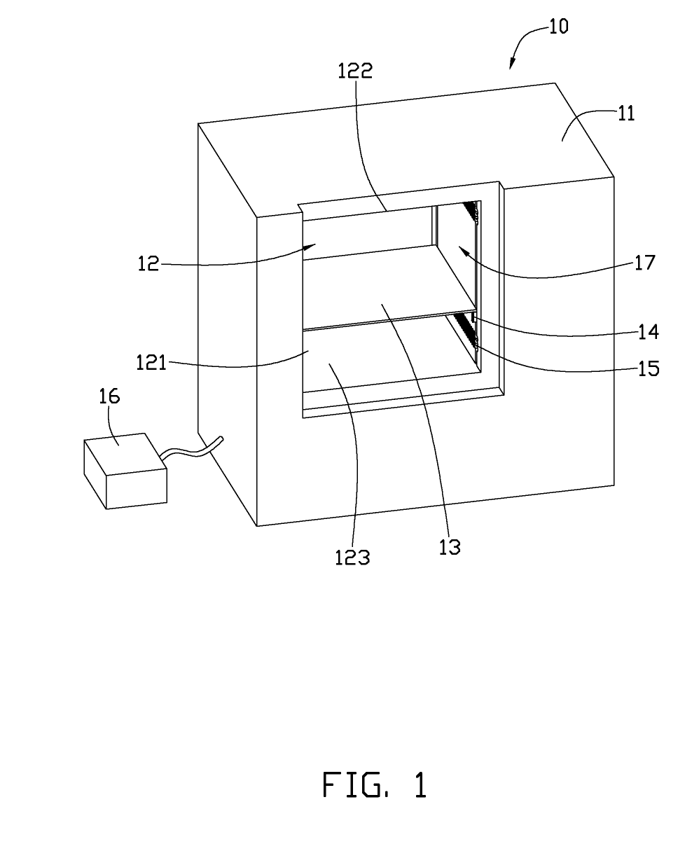

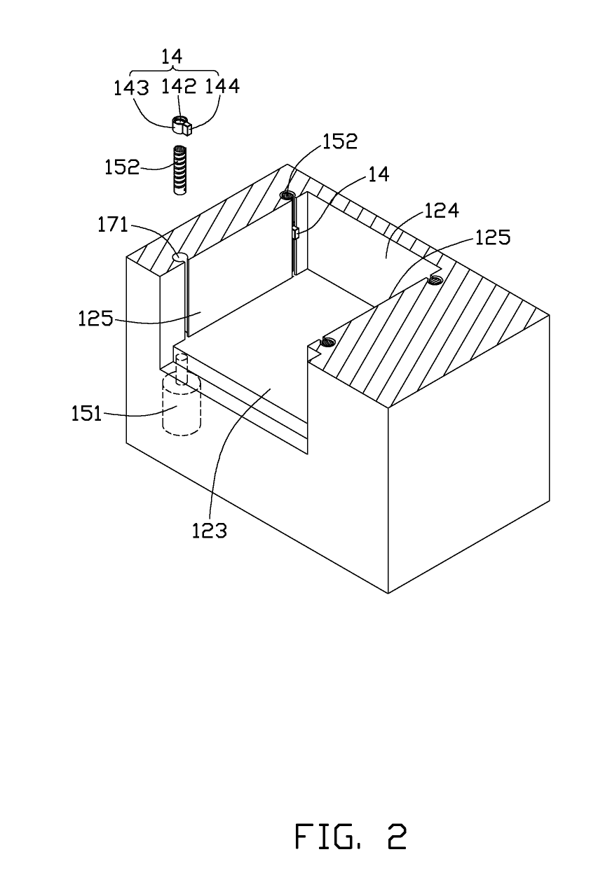

Referring to FIGS. 1 and 2, one embodiment of a temperature and humidity control chamber 10 includes a housing 11 defining a receiving chamber 12, a support frame 13 providing vertical support to a test subject, four elevating members 14 for supporting the support frame 13, four driving assemblies 15 for driving the elevating member 14, and a controller 16 operable to control the four driving assemblies 15. Other components of the temperature and humidity control chamber 10, such as a heater, humidifier, and fan are not shown.

In the illustrated embodiment, the receiving chamber 12 has an opening 121. Thus, the receiving chamber 12 is defined by a top surface 122, a bottom surface 123 opposite to the top surface 122, a rear surface 124 connecting the top surface 122 and the bottom surface 123, and two opposite side surfaces 125. A hinged door, providing access, is not shown.

Each side surface 125 defines two guide grooves 171 extending from the bottom surface 123 to the top surface 122. Each guide groove 171 corresponds to an elevating member 14 and a driving assembly 15. The guide groove 171 has a substantially arcuate shape in cross-section. The driving assembly 15 can actuate the elevating member 14 to move along the guide groove 171 for adjusting the height of the support frame 13. The four driving assemblies 15 are arranged in a matrix, and the four elevating members 14 support the four corners of the support frame 13, respectively.

Each elevating member 14 includes a threaded sleeve 143, an internally threaded segment 142 formed in the threaded sleeve 143, and a support portion 144 radially extending from the circumference of the threaded sleeve 143. The threaded sleeve 143 is slidably received in the guide groove 171, and the support portion 144 is disposed through the opening of the guide groove 171 and is extended to the bottom of the support frame 13 to support the support frame 13 and prevent the elevating member 14 from rotating.

Each driving assembly 15 includes a motor 151 and a threaded bar 152 rotated by the motor 151. The motor 151 is mounted underneath the bottom surface 123, with its output shaft connected to the threaded bar 152. The threaded bar 152 is rotatably received in the guide groove 171, and the threaded sleeve 143 is sleeved on the threaded bar 152 and the threaded segment 142 engages the threaded bar 152. As the threaded bar 152 is rotated, the elevating member 14 is thereby moved to provide linear movement; at the same time, the support portion 144 can prevent the elevating member 14 from rotating along with the threaded bar 152.

The controller 16 is adapted to control the synchronous movement of the four driving assemblies 15. When the threaded bar 152 is rotated by the motor 151 as implemented by the controller 16, the threaded sleeve 143 is moved up and down by the threaded bar 152 along the guide groove 171, such that the vertical position of the support frame 13 can be easily adjusted.

In another embodiment, the driving assembly 15 includes a motor and a gear rotated by the motor, and the elevating member 14 includes a gear rack slidably received in the guide groove 171. The support frame 15 can be moved from a first vertical position to a second vertical position along the guide groove 171 via the engagement of the gear and the gear rack.

It should also be understood that the number of elevating members and driving assemblies utilized in the temperature and humidity control chamber can vary, and is not limited to four as described.

It is believed that the present embodiments and their advantages will be understood from the foregoing description, and it will be apparent that various changes may be made thereto without departing from the spirit and scope of the disclosure or sacrificing all of its material advantages.

1. A temperature and humidity control chamber comprising:
a housing defining a receiving chamber;
a support frame received in the receiving chamber;
at least one elevating member supporting the support frame;
at least one driving assembly mounted on the housing; and
a controller operable to control the at least one driving assembly, wherein the at least one elevating member is capable of moving the support frame from a first vertical position to a second vertical position.

2. The temperature and humidity control chamber of claim 1, wherein the receiving chamber is defined by a top surface, a bottom surface opposite to the top surface, a rear surface connecting the top surface and the bottom surface, and two opposite side surfaces; each side surface defining at least one guide groove in which the corresponding elevating member is received.

3. The temperature and humidity control chamber of claim 2, wherein each guide groove has a substantially arcuate shape in cross-section.

4. The temperature and humidity control chamber of claim 2, wherein comprising four elevating members and four driving assemblies, each side surface defining two guide grooves, each guide groove corresponding to one elevating member and one driving assembly, and the controller controlling the four driving assemblies.

5. The temperature and humidity control chamber of claim 4, wherein the four driving assemblies are arranged in a matrix, and the four elevating members support four corners of the support frame, respectively.

6. The temperature and humidity control chamber of claim 2, wherein each elevating member comprises a threaded sleeve slidably received in the guide groove and a threaded segment formed on the threaded sleeve, and the driving assembly comprises a motor and a threaded bar rotated by the motor, and the threaded bar engaging the threaded segment.

7. The temperature and humidity control chamber of claim 5, wherein each elevating member comprises a support portion radially extending from the threaded sleeve to support the support frame.

8. The temperature and humidity control chamber of claim 1, wherein each driving assembly comprises a motor, a gear rotated by the motor, and each elevating member comprises a gear rack, and the gear rack engaging the gear.

9. A temperature and humidity control chamber comprising:
a housing defining a receiving chamber;
a support frame received in the receiving chamber;
a plurality of elevating members supporting the support frame;
a plurality of driving assemblies mounted on the housing; and
a controller operable to control the plurality of driving assemblies; wherein the plurality of elevating members is capable of moving the support frame to adjust a vertical position of the support frame in the receiving chamber.

10. The temperature and humidity control chamber of claim 9, wherein the receiving chamber is defined by a top surface, a bottom surface opposite to the top surface, a rear surface connecting the top surface and the bottom surface, and two opposite side surfaces; each side surface defining at least one guide groove in which the corresponding elevating member is received.

11. The temperature and humidity control chamber of claim 10, wherein each guide groove has a substantially arcuate shape in cross-section.

12. The temperature and humidity control chamber of claim 10, wherein comprising four elevating members and four driving assemblies, each side surface defining two guide grooves, each guide groove corresponding to one elevating member and one driving assembly, and the controller controlling the four driving assemblies.

13. The temperature and humidity control chamber of claim 12, wherein the four driving assemblies are arranged in a matrix, and the four elevating members support four corners of the support frame, respectively.

14. The temperature and humidity control chamber of claim 11, wherein each elevating member comprises a threaded sleeve slidably received in the guide groove and a threaded segment formed on the threaded sleeve, and the driving assembly comprises a motor, and a threaded bar rotated by the motor, and the threaded bar engaging the threaded segment.

15. The temperature and humidity control chamber of claim 14, wherein each elevating member comprises a support portion radially extending from the threaded sleeve to support the support frame.

16. The temperature and humidity control chamber of claim 9, wherein each driving assembly comprises a motor, a gear rotated by the motor, and each elevating member comprises a gear rack, and the gear rack engaging the gear.
